(19) United States
(12) Patent Application Publication
(10) Pub. No.: US 2014/0129973 A1
(43) Pub. Date: May 8, 2014

(54) INTERACTION MODEL FOR SERVING POPULAR QUERIES IN SEARCH BOX

(71) Applicant: MICROSOFT CORPORATION, Redmond, WA (US)

(72) Inventors: Qingwei Guo, Beijing (CN); Jing Pan, Beijing (CN); Li Zhou, Beijing (CN)

(73) Assignee: MICROSOFT CORPORATION, Redmond, WA (US)

(21) Appl. No.: 13/671,589

(22) Filed: Nov. 8, 2012

(51) Int. Cl. G06F 3/048; G06F 17/30

(52) U.S. Cl. 715/780

(57) ABSTRACT

Architecture that automatically presents a default (e.g., a top popular query) in a search box for viewing and selection by the user. Search users are presented with the default query and other queries less popularly ranked than the default query are presented as suggestions for selection and processing by the search engine or an application. The default query can be presented with graphical emphasis (e.g., grayed text) in the search box to indicate the query is merely presented as a suggestion that may or may not be executed, and the user interface will operate differently based on user interaction. Clicking the search button associated with the search box with the default query results in a search being performed by the search engine or associated local application to fetch additional results. Clicking the search box triggers clean-up of the default query from the search box and other popular queries automatically suggested.

### BACKGROUND

Internet users are attracted by popular events and news which have recently taken place or are currently taking place. If more details of the news are desired, for example, the users may manually search for these details using a search engine using a keyword such as “news” as a query to obtain more related news. However, this model presumes the users take the initiative in getting the more recent or latest news, and fails for users who initially do not intend to search.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture automatically presents a default query (e.g., a top popular query) in a search box for viewing and selection by the user. Thus, both the intending and un-intending search user is presented with the default query (e.g., most popular search query). Other queries less popularly ranked than the default query can then be presented as suggestions (suggested queries) for selection and processing by the search engine or the application that provides such search capabilities. The default query can be presented in the search box with graphical emphasis (e.g., grayed text) to indicate the default query is merely presented as a suggestion, and the user interface will operate differently based on user interaction relative to the search box (and the default query). For example, clicking the search button associated with the search box with the default query will result in a search being performed by the search engine or the application to fetch additional results. Clicking the search box (with the default query) triggers clean-up (removal) of the default query from the search box and other associated popular queries automatically suggested.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a diagram of a search box and suggestion query layout.

FIG. 3 illustrates a diagram of non-selection of the default query by click in the search box and the resulting list of top N popular queries.

FIG. 4 illustrates an alternative system for serving popular queries in a search box in accordance with the disclosed architecture.

FIG. 5 illustrates a method in accordance with the disclosed architecture.

FIG. 6 illustrates an alternative method in accordance with the disclosed architecture.

FIG. 7 illustrates a block diagram of a computing system that executes the interactive model of serving a default query in a search box in accordance with the disclosed architecture.

### DETAILED DESCRIPTION

The disclosed architecture initially automatically inserts a default query (e.g., a top popular query) in search box without user intervention or interaction. Selecting (e.g., clicking) the search button with the default query in the search box results in the search engine or application fetching additional results. Clicking the search box with the default query in the search box results in automatic clean-up (removal) of the default query from the search box and the triggering of an automatic suggestion operation that returns other queries such as top popular queries.

The top N popular queries are fetched from a backend search system (e.g., search engine, application, query analysis system, etc.) for user viewing and interaction in various ways. This solves the problem of automatically informing the user of the popular topics (e.g., events, news) while minimizing the user input effort to find the other topics such as popular topics. As indicated, the disclosed architecture can be implemented for all websites and applications that utilize a search box as a component of a user interface.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

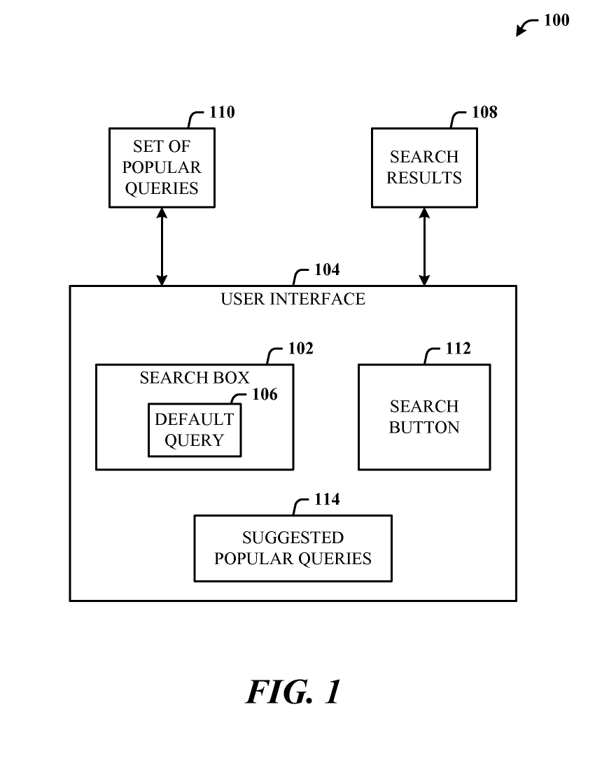

FIG. 1 illustrates a system 100 in accordance with the disclosed architecture. The system 100 can include a search box 102 of a user interface 104 (e.g., a search user interface or application user interface), where the user interface 104 automatically operates to present a default query 106 in the search box 102. The default query 106 is presented in the search box 102 absent a user interaction related to the search box. The absence of the user interaction can be exemplified by the first visit of the user to a website or an application, for example. Other user interactions or lack thereof are described herein below.

In a single user/application scenario, when the user opens a client application (e.g., spreadsheet), the application may typically have a search capability. The default query 106 can be a term (e.g., word, alphanumeric string, etc.) or set of terms most frequently searched in the application by that user. This frequency of use can be obtained based on the user's previous activities in the local client application. For example, if the user has, in the past, searched often for a specific term in an associated application document, upon launching the application, the search box 102 will be populated with that term or terms, but presented as the tentative (default) query. This frequency of use of that term(s) based on the user then becomes the popular term for that user until another term(s) is more frequently searched in the application. Thus, in this single user/application scenario, each application of the user can have a default query computed and stored for presentation upon application launch.

In a multi-user/application scenario, the user (user device) may be on a network where information can be collected from multiple different users that work in the same application to compute the default query 106 for automatic insertion into the search box 102 when any single user launches the application. Thus, each user who launches that application on their computing device (and that has already connected to the network) will be presented with the default query 106 in the search box 102 as computed as the top popular query based on the many other users of the network who work in the same application and have inquired about a common topic related to the default query 106.

The website scenario follows similarly to the above multi-user/application scenario. The user (user device) accesses a network (the web) where information can be collected from multiple different users that initiate web searches at points in time. Based on this knowledge (information), the disclosed architecture computes the default query 106 for automatic insertion into the search box 102 of the user interface (e.g., browser) of any single user that interacts with the website. Thus, each user who launches and directs access to the website via an application (e.g. browser) of their computing device (e.g., cell phone, portable computer, tablet computer, desktop computer, etc.) is presented with the default query 106 in the search box 102 as computed as a popular query (e.g., a top popular query) based on the many other users of the network searching the same information at that time or proximately recent to that point in time.

In other words, when the user initiates access to the website or portal of the search engine, the search engine (and a suggestion engine) operates to derive and present the default query 106 in the search box 102 of the user interface 104.

It is to be understood that the disclosed architecture works in other user interaction or lack of interaction scenarios such as when the user initiates a query and then refreshes the document (e.g., a webpage, application document, etc.), when the search box 102 is the user focus (the input device such as a cursor is in or on the search box 102) but the user then loses focus (cursor is not in or on the search box 102) such that the search box 102 is empty, and when the user visits a website for a second or subsequent times. The default query 106 is processable against a website (e.g., a search website, search capability of a vendor website) or an application (e.g., a word processing program). The default query 106 is graphically represented as a tentative (default) query that may or may not be processed to return search results 108 via a search engine (not shown) or an application. Tentativeness can be represented graphically for quick visual perception and understanding by the user that that default query 106 in the search box 102 was machine derived (e.g., as a current popular query or top popular query).

The default query 106 can be obtained from a query analysis and suggestion component (not shown) that operates as part of or separately from the search engine to process the default query 106 and derive a set of top popular queries 110 (e.g., the top N most popular queries at the time or recent past).

Representation of the default query 106 as a tentative query can be by graphical means such as applying graphical emphasis to the query 106, which includes, but is not limited to, bolding, italicization, changes in transparency, colorization, underlining, font size, font type, etc., or any combination thereof, as desired. In the embodiments herein, the graphical emphasis changes the transparency of the query 106 such that the query characters/words appear visually to be a faded gray color, rather than a solid black, as may typically be used for characters.

The default query 106 is processed in response to interaction with a search button 112 associated with the search box 102. The user interface 104 presents suggested popular queries 114 (e.g., less popular than the default query 106 proximate (e.g., below, to the right, etc.) the search box 102, the popular queries derived from a suggestion algorithm (or engine). In one implementation, the default query 106 can be the top popular query of the set of popular queries 110 that are derived and automatically presented in the search box 102 for viewing (e.g., as part of accessing a search engine website, portal, or local application).

The user interface 104 clears the search box 102 of the default query 106 in response to interaction (e.g., clicking, touching on a touch screen, voice control, etc.) with the search box 102. The user interface 104 also presents a list of latest popular queries in response to interaction with the search box 102. The latest popular queries of the list are presented as active objects (programmatically responsive to a user interaction) each selectable as a query to be processed. The user interface 104 both clears the search box 102 of the default query 106 and presents a list of the latest popular queries in response to interaction with the search box 102.

Put another way, the top single popular query is selected as a default (tentative) query 106 in the search box 102, in a faded gray color. When the user visits a website (e.g., search engine or portal) or launches (opens) an application, the user views the top popular query (default query 106) and consequently, knows the popular news, where news and events are the searched-for information. When the user clicks directly on the search button 112, the default query 106 (e.g., a popular query) is used as the user query to search in the search engine or the application to get related information (e.g., news). This obviates the need for manual user input of the query.

When the user clicks (selects, as a user interaction) on the search box 102, the default query 106 (e.g., popular query) is cleared showing the search box 102 as blank (or empty). This ensures that no extra effort is required of the user when the user chooses to perform a search using a different query than the default query 106.

When the user selects (e.g., clicks on) the search box 102 and does not immediately input a different query, the top N (where N is an integer) popular queries, are presented (e.g., in a drop-down menu, or flyout box (a box that appears to be structurally attached to a user interface object), based on what is popular at this point in time or recently as derived by the query analysis and suggestion component (e.g., which may be designed as part of the search engine or an application). This quickly provides the user with popular information for further searching, if desired. When the user enters a new query (other than the default query 106) in the search box 102, an automatic suggest operation occurs to show the suggested queries 114.

The suggested queries 114 include the top 2-N popular queries, which may be presented as clickable objects below the search box 102. Selecting (e.g., clicking, using an input device, voice activation, etc.) on one of the suggested queries 114 (e.g., popular) results in a single search using the associated suggestion query. This enables the user know what is the popular, for example, information related to that selected suggestion query.

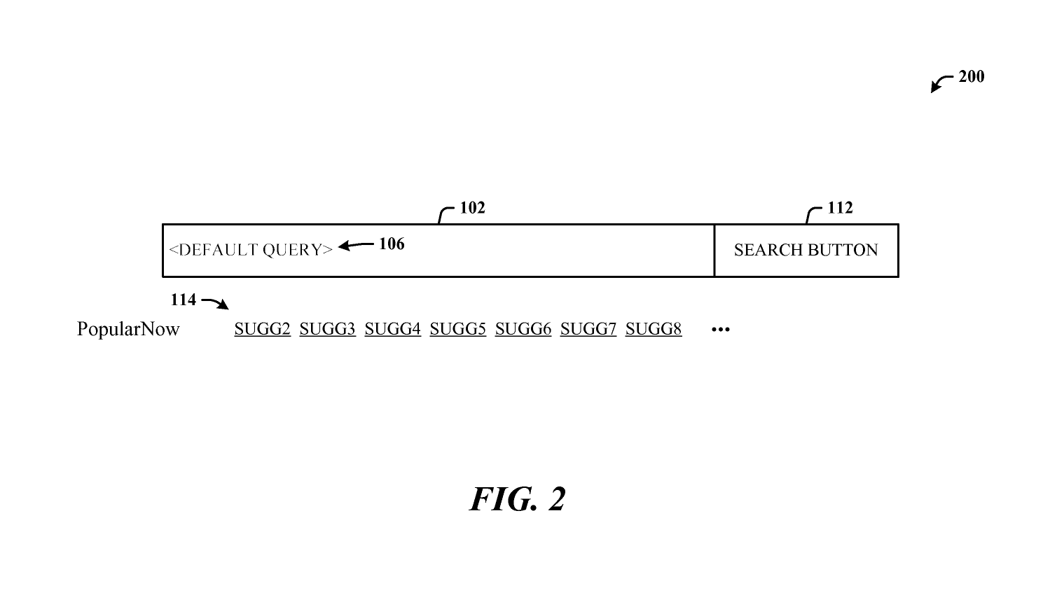

FIG. 2 illustrates a diagram 200 of the search box 102 and suggestion query layout. The diagram 200 shows the search box 102 and the search button 112 as presented in the search user interface (e.g., for a browser and application). The default query 106 (e.g., a popular query) is automatically presented in the search box 102 when the user accesses a search website, search portal, or a local application having such capabilities. Thus, the user does not need to manually enter a query to determine the latest information of a particular topic of interest. The default query 106 is automatically computed and presented to the user (e.g., as a top popular query). As a starting point, the default query 106 can be related to a popular general category of interest such as the news or events.

In association with the default query 106, the user interface presents the next most suggested popular queries 114 as computed by the current search framework (for an application or website). In order to provide a variety of possible popular interests, the suggested popular queries 114 can include the next 2-N most popular queries of all categories of interest (e.g., news, sports, medicine, Hollywood, etc.), or of a specific category of interest (e.g., sports). Here, the default query 106 is presented as faded gray text to visually indicate that the default query (e.g., a top popular query) is a tentative query—it can be selected for processing or cleared for a different query. If the user selects the search button 112, the default query 106 will be processed to return related search results. If the user clicks in the search box 102, another list of popular queries is computed and presented.

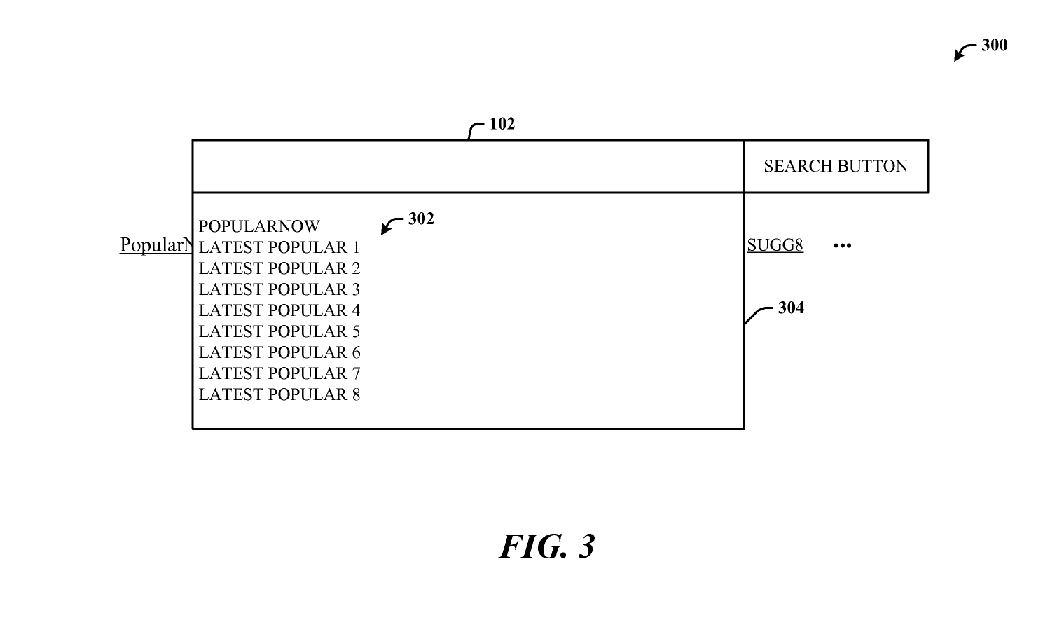

FIG. 3 illustrates a diagram 300 of non-selection of the default query 106 by click in the search box 102 and the resulting list 302 of top N popular queries. When the user chooses to not utilize the default query 106 (as shown in FIG. 2), the user clicks in the search box 102, which results in default query clean-up and the trigger of the currently most popular queries. Here, the list 302 of most popular queries is shown as a ranked list in a dropdown menu 304. Alternatively, the list 302 can be presented to the right of the search box 102, or in other ways commonly employed to show information (e.g., flyout panes or boxes).

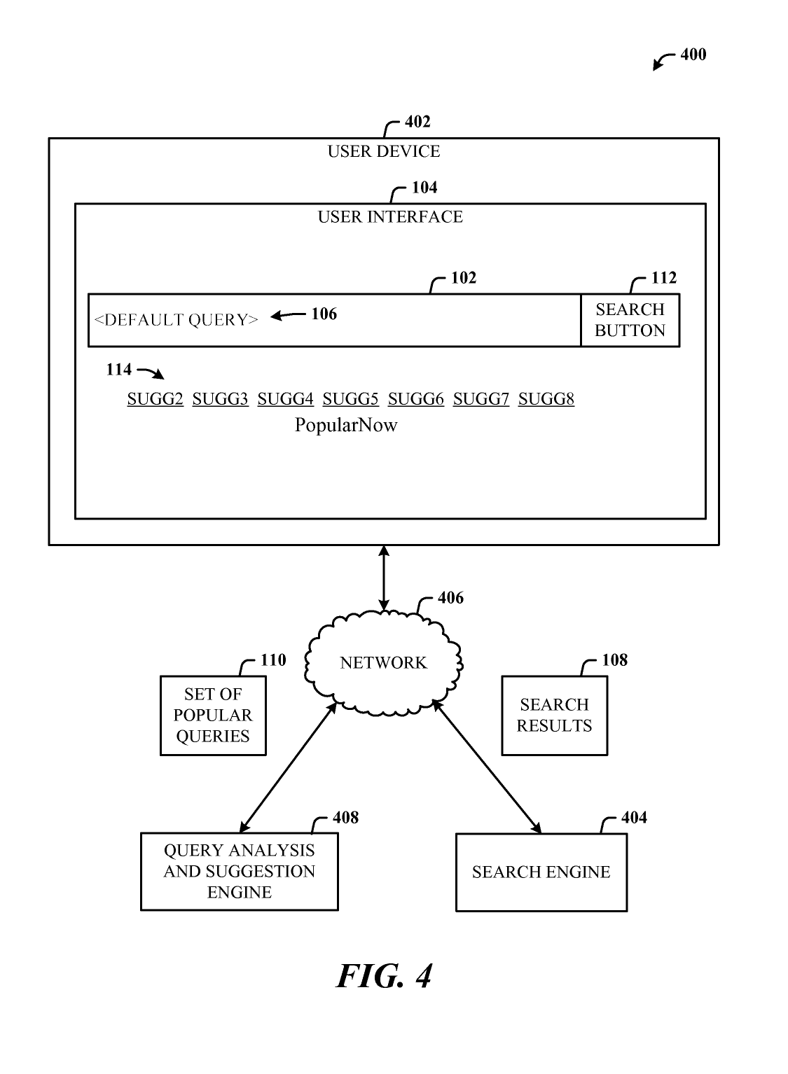

FIG. 4 illustrates an alternative system 400 for serving popular queries in a search box in accordance with the disclosed architecture. The system 400 shows a user device 402 (e.g., cell phone, tablet computer, portable computer, desktop computer, etc.) used to interface to a search engine 404 on a network 406 for processing a query and returning the search results 108. The user device 402 can also automatically access a query analysis and suggestion engine 408 that interfaces to the search engine 404 to compute the suggested popular queries 114 and the default query 106 (e.g., top popular query). The user interface 104 can be part of a search engine results page (SERP) or a different page therefrom such as a local or distributed application.

It is to be appreciated that, alternatively than what is depicted, the query analysis and suggestion component 408 can be designed as part of the search engine 404 (or separalta local application). Thus, the default query 106 and the top 2-N suggested popular queries will be sent from the search engine 404 as a ranked set. With respect to employing a top popular query, the top popular query is inserted into the search box 102 and the suggested popular queries 114 are presented under the search box 102 as a ranked set (in decreasing rank order from left to right) from Sugg2 as the second highest ranked suggested query to Sugg8 as the bottom ranked suggested query. As before, the default query 106 is depicted in such a way that the viewer understands it is machine derived and suggested as a default query as related to the most popular topic at that time, and as presented the first time the user accesses the search engine 404 (or local application in such a scenario).

It is also within contemplation of the disclosed architecture that in a subsequent search operation, after the first instance of viewing the search interface 104 and perhaps some interaction with the search box 102 and/or search button 112, if the user fails to timely interact with the search box 102, search button 112, and presented search results before a predetermined timeout, the search engine 404 (and query analysis and suggestion engine 408) will automatically operate to regenerate a new default query (e.g., the latest popular queries at that new later time) for presentation and viewing. For example, if the user fails to interact with the user interface 104 (e.g., walks away from the device 402) for an extended period of time, a timeout can automatically cause a refresh of the user interface page, which then causes the regeneration of the default query 106 to possibly a new top popular query.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

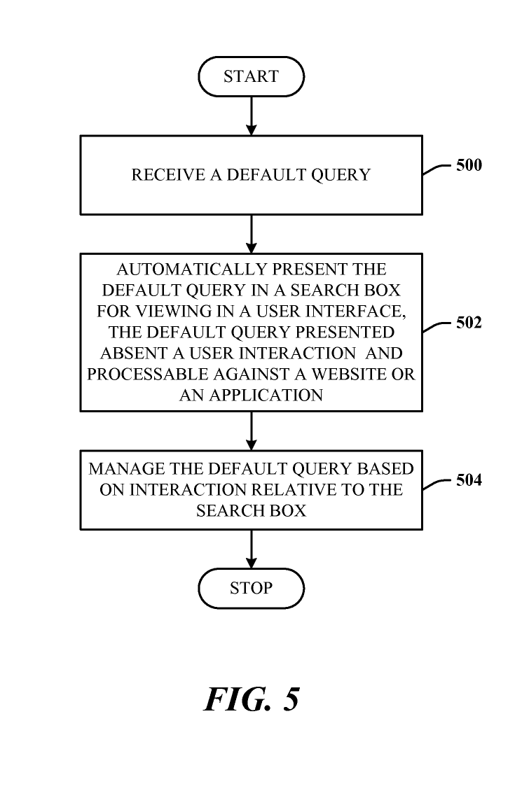

FIG. 5 illustrates a method in accordance with the disclosed architecture. The method can be performed by a computer system executing machine-readable instructions. At 500, a default query is received (e.g., as computed from a query popularity analysis system). At 502, the default query is automatically presented in a search box for viewing in a user interface, the default query presented absent a user interaction and processable against a website or an application. At 504, the default query is managed (e.g., selected or avoided) based on interaction relative to the search box.

The method can further comprise presenting the default query (e.g., the top popular query) with graphical emphasis (e.g., faded gray characters) that indicates the default query is a tentative query. The method can further comprise executing the default query in response to interaction with a search object (search button) proximate the search box. The method can further comprise presenting suggested less popular queries (the queries 114) proximate the search box. The method can further comprise clearing the search box of the default query in response to interaction with the search box. The method can further comprise presenting a top popular query as the default query. The method can further comprise presenting a list of latest popular queries (the list 302) in response to interaction (clicking in) with the search box.

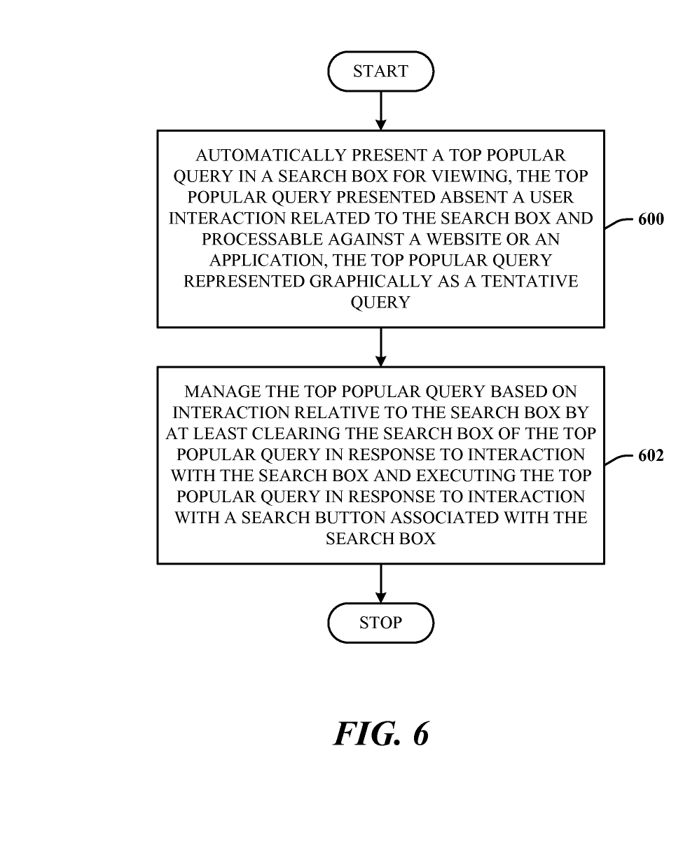

FIG. 6 illustrates an alternative method in accordance with the disclosed architecture. The method can be performed by a computer system executing machine-readable instructions. At 600, a top popular query is automatically presented in a search box for viewing, the top popular query presented absent a user interaction related to the search box and processable against a website or an application, and the top popular query is represented graphically as a tentative query. At 602, the top popular query is managed based on interaction relative to the search box by at least clearing the search box of the top popular query in response to interaction with the search box and executing the top popular query in response to interaction with a search button associated with the search box.

The method can further comprise presenting suggested less popular queries proximate the search box. The method can further comprise presenting a list of latest popular queries in response to interaction with the search box. The method can further comprise presenting other top popular queries in response to clearing the search box. The method can further comprise presenting the top popular query as a passive object (not directly interactive) in the search box.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server itself can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

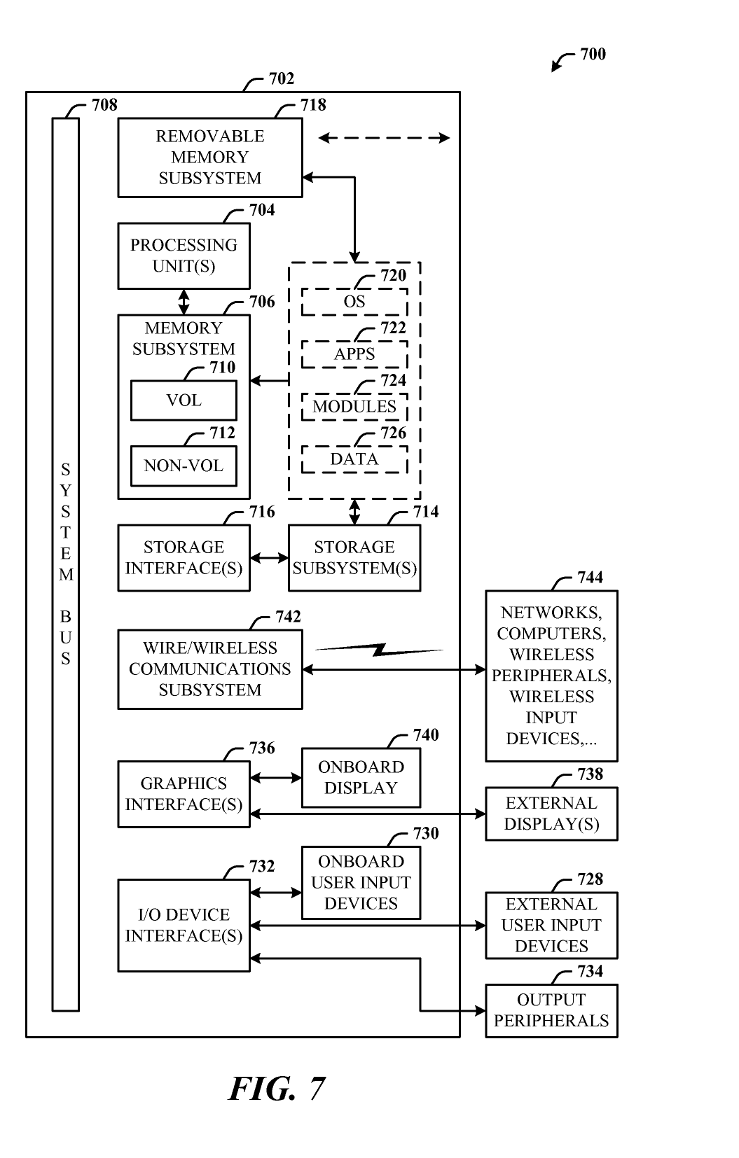

Referring now to FIG. 7, there is illustrated a block diagram of a computing system 700 that executes the interactive model of serving a default query in a search box in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704 (also referred to as microprocessor(s) and processor(s)), a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 702 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the diagram 200 of FIG. 2, entities and components of the diagram 300 of FIG. 3, the entities and components of the system 400 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that does not employ propagated signals, can be accessed by the computer 702, and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a search box of a search user interface, the search user interface automatically presents a default query in the search box for viewing, the default query presented absent a user interaction related to the search box and processable against a website or an application, the default query graphically represented as a tentative query; and
a microprocessor that executes computer-executable instructions associated with the search user interface.

2. The system of claim 1, wherein the default query is processed in response to interaction with a search button associated with the search box.

3. The system of claim 1, wherein the search user interface presents suggested less popular queries than the default query proximate the search box.

4. The system of claim 1, wherein the search user interface clears the search box of the default query in response to interaction with the search box.

5. The system of claim 1, wherein the search user interface presents a list of latest popular queries in response to interaction with the search box.

6. The system of claim 5, wherein the latest popular queries of the list are presented as active objects each selectable as a query to be processed.

7. The system of claim 1, wherein the default query is a top popular query that is automatically presented in the search box for viewing as part of accessing the website or the application.

8. The system of claim 1, wherein the search user interface clears the search box of the default query in response to interaction with the search box and presents a list of latest popular queries in response to interaction with the search box.

9. A method performed by a computer system executing machine-readable instructions, the method comprising acts of:
receiving a default query;
automatically presenting the default query in a search box for viewing in a user interface, the default query presented absent a user interaction and processable against a website or an application; and
managing the default query based on interaction relative to the search box.

10. The method of claim 9, further comprising presenting the default query with graphical emphasis that indicates the default query is a tentative query.

11. The method of claim 9, further comprising executing the default query in response to interaction with a search object proximate the search box.

12. The method of claim 9, further comprising presenting suggested less popular queries proximate the search box.

13. The method of claim 9, further comprising clearing the search box of the default query in response to interaction with the search box.

14. The method of claim 9, further comprising presenting a top popular query as the default query.

15. The method of claim 9, further comprising presenting a list of latest popular queries in response to interaction with the search box.

16. A method performed by a computer system executing machine-readable instructions, the method comprising acts of:
automatically presenting a top popular query in a search box for viewing, the top popular query presented absent a user interaction related to the search box and processable against a website or an application, the top popular query represented graphically as a tentative query; and
managing the top popular query based on interaction relative to the search box by at least clearing the search box of the top popular query in response to interaction with the search box and executing the top popular query in response to interaction with a search button associated with the search box.

17. The method of claim 16, further comprising presenting suggested less popular queries proximate the search box.

18. The method of claim 16, further comprising presenting a list of latest popular queries in response to interaction with the search box.

19. The method of claim 16, further comprising presenting other top popular queries in response to clearing the search box.

20. The method of claim 16, further comprising presenting the top popular query as a passive object in the search box.
